(19) United States
(12) Patent Application Publication
(10) Pub. No.: US 2026/0246190 A1
(43) Pub. Date: Aug. 20, 2026

(54) Detachable and Replaceable Connector Base Structure for Lithium-Ion Power Tool Battery Pack

(71) Applicant: Zhejiang Rongpeng Air Tools Co., Ltd., Taizhou City (CN)

(72) Inventors: Xiaorong Li, Taizhou City (CN); Xiaopeng Li, Taizhou City (CN)

(21) Appl. No.: 19/540,912

(22) Filed: Feb. 16, 2026

(30) Foreign Application Priority Data
Feb. 19, 2025 (CN) 202520266129.0

(51) Int. Cl. H01R 13/514; H01M 50/213; H01M 50/244; H01M 50/247; H01R 13/627; H01R 13/631; H01R 13/639

(52) U.S. Cl. CPC H01R 13/514; H01M 50/213; H01M 50/244; H01M 50/247; H01R 13/6273; H01R 13/6315; H01R 13/639

(57) ABSTRACT

A detachable and replaceable connector base structure for a lithium-ion power tool battery pack includes a housing with a detachable connector base at its bottom. A positioning structure between the base and the housing secures the base in place while permitting removal, and a buckle mechanism on the battery pack locks the battery pack to the base. Conductive inserts in the base provide electrical connection to the tool's circuitry. This design allows the power tool to interchangeably use battery packs of different brands or models without requiring any modification to the tool housing.

### FIELD OF THE INVENTION

The present invention relates to the field of battery-powered tools, and more particularly to a detachable and replaceable connector base structure for a lithium-ion power tool battery pack.

### BACKGROUND OF THE INVENTION

Battery-powered tools that utilize lithium-ion battery packs are widely used. Most current cordless power tools are designed to work with a dedicated rechargeable battery pack, and the tool housing is built with an integrated connector (buckle) structure tailored to that specific battery pack model. However, this design has certain drawbacks. The housing is typically pre-molded to accommodate only the designated battery pack and cannot readily be adapted for battery packs of different brands or models. As a result, manufacturers cannot easily offer compatibility with various battery systems, which leads to inconvenience in both production and use.

### SUMMARY OF THE INVENTION

It is an object of the present invention to provide a detachable and replaceable connector base structure for a lithium-ion power tool battery pack, so as to overcome the above-mentioned drawbacks of existing designs.

To achieve the above object, the present invention provides the following technical solution: A detachable and replaceable connector base structure for a lithium-ion power tool battery pack, including a housing (1) with a circuit board (2) disposed at the bottom of the housing. A connector base (3) is detachably mounted at the bottom of the housing (1) to support a battery pack (4). A positioning structure is provided between the connector base (3) and the housing (1) to form a secure but detachable connection. The battery pack (4) is equipped with a buckle structure that engages the connector base (3), and the connector base (3) further incorporates a plurality of conductive inserts (5) that are electrically connected to the circuit board (2) in the housing.

In one embodiment, the positioning structure is provided on both side surfaces of the connector base (3) and the housing (1), for example comprising a positioning protrusion (6) on the connector base and a complementary positioning groove (7) on the housing. The connector base (3) may also include an installation groove (8) at its bottom for receiving the battery pack (4), such that the battery pack (4) is secured to the connector base (3) by the engagement of the installation groove (8) with the buckle structure.

Compared to prior art fixed battery mounts, the connector base structure of the present invention allows a power tool to use battery packs of different brands or models interchangeably without modifying the tool's housing. The detachable connector base can be quickly installed or replaced according to the battery pack needed, providing greater versatility in production and convenience in use.

### BRIEF DESCRIPTION OF THE DRAWINGS

FIG. 1 is an exploded view of the present invention;

FIG. 2 is a perspective view of the present invention;

FIG. 3 is a perspective view of one half of the housing of the present invention;

FIG. 4 is a perspective view of the connector base of the present invention.

### DETAILED DESCRIPTION OF THE PREFERRED EMBODIMENTS

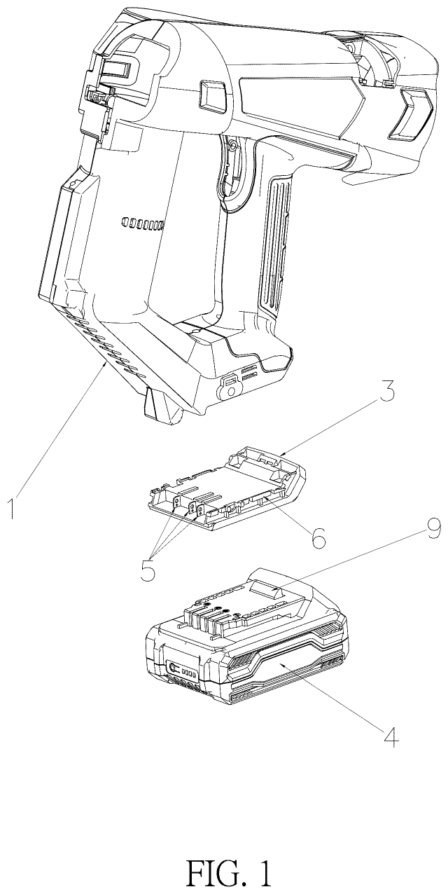

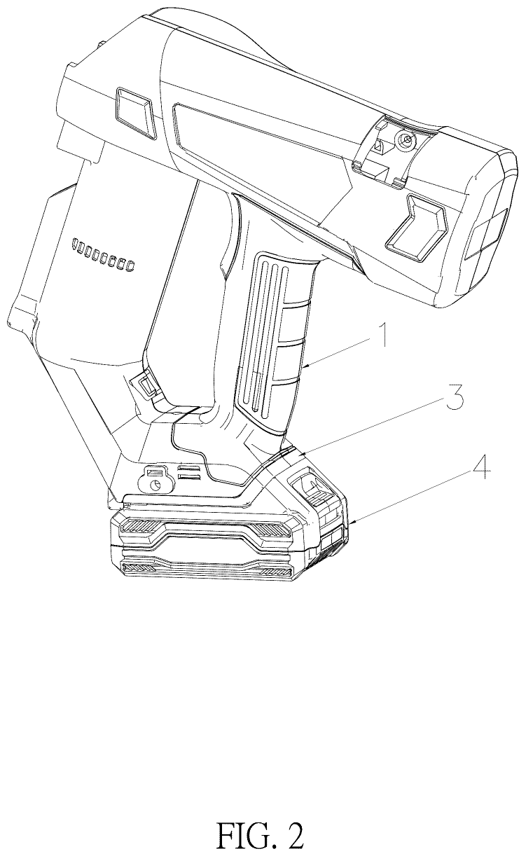

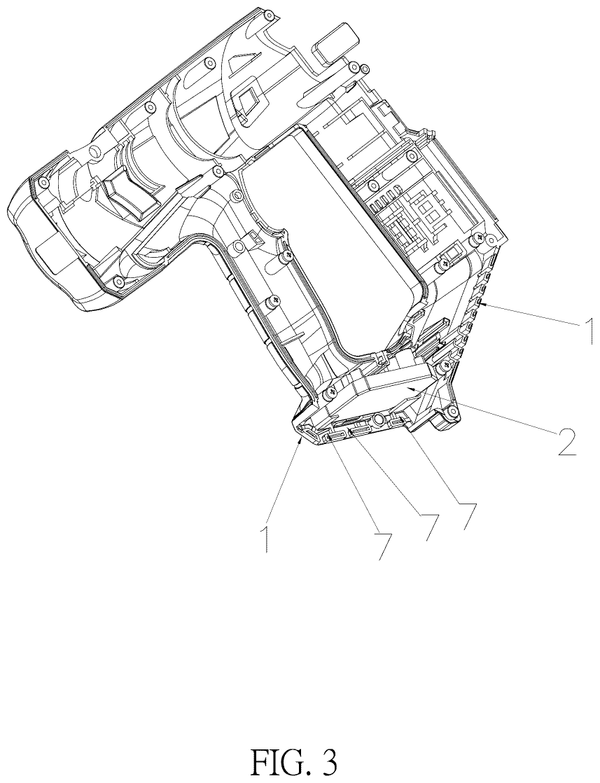

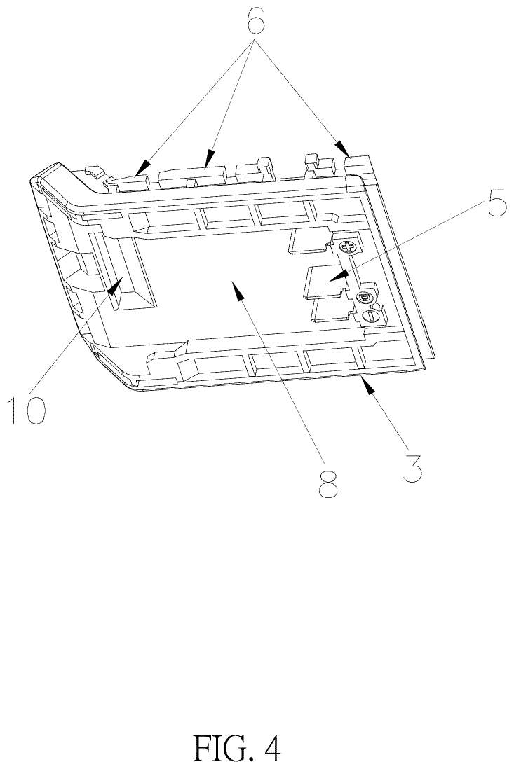

Referring to FIGS. 1 to 4, a preferred embodiment of the present invention is described in detail. The detachable and replaceable connector base structure for a lithium-ion power tool battery pack includes a housing (1) with a circuit board (2) arranged at the bottom inside the housing (1). A connector base (3) is disposed at the bottom of the housing (1) and is detachably connected to the housing. A positioning structure is provided between the connector base (3) and the housing (1) to form a detachable fixed connection. In this embodiment, the positioning structure comprises a positioning protrusion (6) on the connector base (3) and a corresponding positioning groove (7) on the housing (1), which engage with each other to secure the connector base in place.

The battery pack (4) is attached to the connector base (3) by a buckle structure. Specifically, the connector base (3) includes an installation groove (8) on its bottom side to receive a portion of the battery pack (4). When the battery pack (4) is mounted on the connector base (3), a push-type spring latch (9) on the battery pack engages a buckle groove (10) on the connector base (3), locking the battery pack to the connector base. The connector base (3) is provided with multiple conductive inserts (5) that connect to the circuit board (2), thereby establishing an electrical connection between the battery pack (4) and the tool's internal circuitry.

To use a battery pack of a different brand or type, the user can remove the currently attached battery pack (4) by pressing the spring latch (9) to disengage it from the buckle groove (10). Once the battery pack is removed, the connector base (3) can be detached from the housing (1) by disengaging the positioning protrusion (6) from the positioning groove (7). A different connector base, designed for another battery pack standard, can then be attached to the housing (1) in place of the original connector base. This modular design enables quick conversion of the tool to accommodate various battery pack interfaces without any permanent modifications to the tool housing or electrical system.

The above-described embodiment of the present invention is intended to illustrate the technical concepts and advantages of the detachable and replaceable connector base structure. These embodiments facilitate an understanding of the invention and are not intended to limit its scope. Those skilled in the art can make various modifications and changes to the described structure without departing from the spirit and scope of the invention, as defined by the appended claims.

What is claimed is:

1. A detachable and replaceable connector base structure for a lithium-ion power tool battery pack, comprising:
a housing; a circuit board positioned at the bottom of the housing;
a connector base disposed at the bottom of the housing and detachably connected to the housing;
a positioning structure provided between the connector base and the housing to form a detachable fixed connection between the connector base and the housing;
wherein the battery pack includes a buckle structure configured to engage the connector base; and wherein the connector base comprises a plurality of conductive inserts electrically connected to the circuit board.

2. The detachable and replaceable connector base structure according to claim 1, wherein the positioning structure is provided on both side surfaces of the connector base and the housing.

3. The detachable and replaceable connector base structure according to claim 1, wherein the positioning structure comprises a positioning protrusion on one of the connector base and the housing, and a corresponding positioning groove on the other of the connector base and the housing.

4. The detachable and replaceable connector base structure according to claim 1, wherein an installation groove for mounting the battery pack is provided at the bottom of the connector base, and the battery pack is connected to the connector base via the installation groove and the buckle structure.

5. The detachable and replaceable connector base structure according to claim 4, wherein the buckle structure comprises a push-type spring latch on the battery pack and a buckle groove on the connector base.
